(19) United States
(12) Patent Application Publication
(10) Pub. No.: US 2009/0308856 A1
(43) Pub. Date: Dec. 17, 2009

(54) Vehicle fender well/underbody deicer system

(76) Inventor: Lester Virgil Collick, Plainwell, MI (US)

Correspondence Address: Lester V. Collick, 1035 Fairlane Road, Plainwell, MI, 49080, US

(21) Appl. No.: 12/157,732

(22) Filed: Jun. 13, 2008

(51) Int. Cl. B60L 1/02

(52) U.S. Cl. 219/202

(57) ABSTRACT

This system is engineered to prevent the intrusive buildup of ice on the “Fender-well” and “Under-body” areas of a vehicle that become, dangerous, for the host vehicle, fellow road vehicles, and unsightly, for housekeeping, when ice falls off in big chunks. Accomplished by the employment of a controlled heat system. Installed directly in-line with the fender-wells, from end to end of the vehicle, on the bottom side of the body parts, and ample width to accommodate the tire-width used on the vehicle. The heat can be derived from, electricity, or any conductive media, or liquid. The system can be employed as a continuous loop, or zoned by using an alternating controller block, to reduce energy requirements. The system can be installed “After Market” by means of mechanical fasteners, or with chemical adhesives, or at “manufacturing” by incorporating the “Heat Elements” into the body parts.

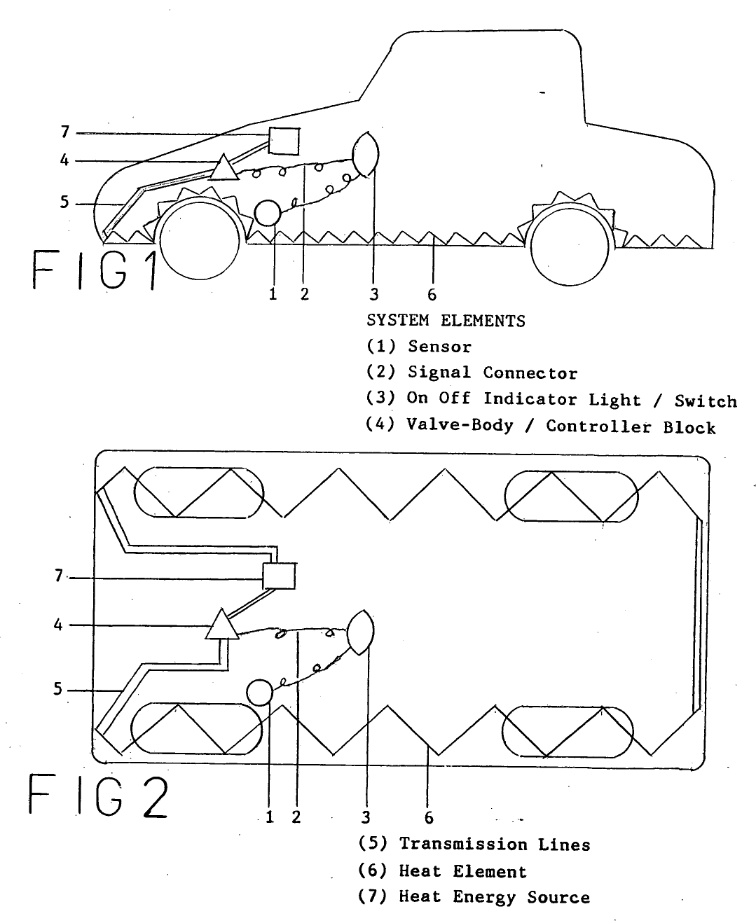

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

There is a long-standing public road hazard in snow covered areas of the world. The hazard is caused by the “Vehicle Fender-well” and “Under-body” buildup of ice, while traveling the roadways.

After driving straight for a period of time the “Vehicle Fender-wells” can become, so impacted around the wheels, that it renders the vehicle not steerable. When this buildup of ice, randomly falls off, in chunks, because of their weight and density, become an inherent danger to any vehicle that may strike them. The buildup of ice in the fender-wells and the under-body of vehicles limits the effectiveness of a wash-job, to remove corrosives. The ice buildup dropped in parking-lots, driveways, and garages are unsightly, and create a nuisance. This system will eliminate all of the afore stated hazards and problems.

### BRIEF SUMMARY OF THE INVENTION

This system is engineered to prevent the intrusive buildup of ice on the “Fender-well” and “Under-body” areas of a vehicle, that become, dangerous, for the host vehicle, fellow road vehicles, and unsightly, for housekeeping, when ice falls off in big chunks.

This is accomplished by the employment of a controlled heat system. The heat can be derived from, electricity, or any conductive media, or liquid. The system can be employed as a continuous loop, or zoned by using an alternating controller block, to reduce energy requirements. The system can be installed “After Market” by means of mechanical fasteners, or with chemical adhesives, or at “Manufacturing” by incorporating the “Heat Elements” into the body parts.

### BRIEF DESCRIPTION OF THE SEVERAL VIEWS OF THE DRAWING

Referencing the “Drawing” page: One (1) of one (1), Figure one (1): Depicts a “Vehicle Side View”. With the elements of the system referenced by number, from one (1), to seven (7).

The system elements are:

(1) Sensor

(2) Signal Connector

(3) On Off Indicator Light/Switch

(4) Valve-Body/Controller Block

(5) Transmission Lines

(6) Heat Element

(7) Heat Energy Source

Figure two (2): Is a “Bottom View of a Vehicle”. With the same, one (1) through seven (7) system elements, listed in figure one (1). Both figure one (1), and two (2), depict the “Location” of (6), the “Heat Element”. The “Location” of (6), the “Heat Element” being the “Claim”, of the patent application.

### DETAILED DESCRIPTION OF THE INVENTION

This invented use, because of the location, of a “Heat Element”, eliminates, the dangerous and unwanted buildup of ice on the “Fender-well and Under-body” areas of a vehicle. Reference: Figure one (1), and two (2), on the “Drawing” page; one (1), of one (1). This system utilizes the technology of “Heat Elements”, (6). The “Heat Element”, can be electrically, gas, conductive media, or liquid, energized. The “Heat Elements”, are installed in-line with the fender-wells on the bottom side of the body parts. It is important that the “Heat Element”, width be appropriate for the tire-width used on the vehicle, to accommodate the “Splash” distance that may occur beyond the tread-width. (6), the “Heat Element”, will be installed “After Market”, either with “Mechanical Fasteners”, or with “Chemical Adhesives”. Applied pickup bed-liner material is an example of a functional “Chemical Adhesive”. Put one layer on, while still tacky, apply (6), the “Heat Element”, then apply another coat, for added adhesion, and protection. For “Original Manufactured Equipment” (OME) (6), the “Heat Element” can be incorporated in the body parts.

The function of the system is preformed as follows: First: (1), the “Sensor”, detects ice buildup conditions. The sensor is of the same technology as the sensors used in automatic run windshield wiper systems, that detect water on the windshield engaging the system. The sensor gives buffer for the operators' position of liability, that might occur if it were a manual system, and the operator waited too long to engage the system, and became responsible for releasing a chunk of ice, which was later stuck by another. Second: (1), sends a signal through; (2), the “Signal Connector”, (2), the “Signal Connector”, can be electric wire, or tubular. Third: (3), the dash mounted, “On-Off Indicator Light/Switch”, receives the signal, (3)s, function is to light an “On” indicator light, and sent the signal on. (3), may have an “On” override switch, so the operator can engage the system for drying purposes at his/her discretion. (4), “Valve Body/Controller Block” controls the source of energy released to the fender wells that require de-icing. (5), “Transmission Lines” connect the (7), “Heat Energy Source” to the (4), “Valve Body/Controller Block” enabling energy to be transmitted equally to the desired areas for de-icing. (6), “Heat Elements” are fastened to the under body, fender wells, from the (5), “Transmission Lines” allowing for a continuous flow of heat energy when the (2), “Signal Connector” is activated on the instrument panel. (7), “Heat Energy Source” could be a battery or an electrical generator device allowing for a continuous flow of energy through the system.

What I claim is:

1. A “Heat Element” employed on a vehicles' “Fender-well and Under-body” areas, in-line with the “Fender-wells”, and on the bottom side of the body parts, with application appropriate width, while operating, will; eliminate the buildup of ice, on those “Fender-well and Under-body” areas of a vehicle.
